(19) United States
(12) Patent Application Publication
(10) Pub. No.: US 2018/0292594 A1
(43) Pub. Date: Oct. 11, 2018

(54) BACKLIGHT MODULE AND DISPLAY APPARATUS

(71) Applicants: HKC Corporation Limited, Shenzhen City ,Guangdong (CN); Chongqing HKC Optoelectronics Technology Co., Ltd., Chongqing (CN)

(72) Inventor: Chia-Hang LEE, Chongqing (CN)

(21) Appl. No.: 15/555,654

(22) PCT Filed: Apr. 13, 2017
(86) PCT No.: PCT/CN2017/080379

§ 371 Date: Sep. 5, 2017

(30) Foreign Application Priority Data
Dec. 31, 2016 (CN) 201611268441.5

(51) Int. Cl. F21V 8/00

(52) U.S. Cl. CPC G02B 6/0043; G02B 6/0061; G02B 6/0003

(57) ABSTRACT

The present disclosure relates to a backlight module and a display apparatus. The backlight module includes at least one light source; a light guide plate, including a bottom surface and a plurality of screen dot recessed parts arranged in a two-dimensional manner, where the screen dot recessed parts are located on the bottom surface, and each of the screen dot recessed parts is filled with a quantum dot material; and a substrate, disposed on the bottom surface of the light guide plate, and sealing the quantum dot material in the screen dot recessed parts of the light guide plate. The display apparatus includes a display panel and the backlight module.

### BACKGROUND

### Technical Field

The present disclosure relates to a backlight module and a display apparatus, and in particular, to a backlight module and a display apparatus that seal a quantum dot material in a light guide plate.

### Related Art

In recent years, with the development of technologies, many different display devices, such as liquid crystal displays (LCD) or Electro luminescence (EL) display devices, are widely applied to flat displays. Using liquid crystal displays as an example, most liquid crystal displays are backlit liquid crystal displays, and each backlit liquid crystal display includes a crystal display panel and a backlight module. The crystal display panel is formed by two transparent substrates and liquid crystal encapsulated between the substrates.

A quantum dot, a nanocrystal whose diameter is equal to or less than 10 nanometers (nm), is made of a semiconductor material, and causes a quantum confinement effect. Compared with typical Phosphor, the quantum dot generates denser light in a relatively narrow band. When electrons in an excited state are transmitted from a conduction band to a valence band, the quantum dot generates light, and has a feature that the wavelength of a material changes according to the size of a particle. Because the wavelength changes according to the size of the quantum dot, light of a required wavelength area may be obtained by controlling the size of the quantum dot.

A quantum dot enhancement film (QDEF) is an optical component currently used in a backlight module, and is used for displaying more precise colors of a display. The principle of the QDEF is that: Two types of quantum dots in a large quantity are disposed on a thin film; blue light is used as a backlight source; when the blue light is illuminated to the two types of quantum dots, the blue light is separately converted to red light and green light; the generated red light and green light are mixed into white light together with the blue light; by changing a ratio of which the blue light is converted to the red light and the green light, so that an effect of the mixed color is closer to an actual color, and displayed colors of the display is more precise. Therefore, a designing manner, in which high efficiency is achieved by means of a quantum dot material, and that has high producibility, is currently one of important topics.

### SUMMARY

To resolve the foregoing technical problem, an objective of the present disclosure is to provide a backlight module and a display apparatus using quantum dots.

The objective of the present disclosure is achieved and the technical problem of the present disclosure is resolved by using the following technical solutions. A backlight module provided according to the present disclosure comprises:

at least one light source;

a light guide plate, comprising a bottom surface and a plurality of screen dot recessed parts arranged in a two-dimensional manner, where the screen dot recessed parts are located on the bottom surface, and each of the screen dot recessed parts is filled with a quantum dot material; and

a substrate, disposed on the bottom surface of the light guide plate, and sealing the quantum dot material in the screen dot recessed parts of the light guide plate.

In some embodiments, the substrate comprises a reflective surface, to reflect light.

In some embodiments, a refractive index coefficient of the substrate is less than or equal to a refractive index coefficient of the light guide plate, so as to form total reflection and reflect light.

In some embodiments, light excited by the light source has a wavelength in a range of 435 nanometers to 470 nanometers.

In some embodiments, the density of the screen dot recessed parts disposed decreases in a direction towards the light source and increases in a direction away from the light source, so that backlight provided by the backlight module can be more evenly.

In some embodiments, the quantum dot material has a yellow quantum dot material and a green quantum dot material.

In some embodiments, each screen dot recessed part further comprises a separation glue, used for sealing the quantum dot material, to avoid water vapor.

Another objective of the present disclosure is to provide a display apparatus, comprising the backlight module; and a display panel, configured to display an image.

Still another objective of the present disclosure is to provide a backlight module, comprising:

at least one light source, exciting light having a wavelength in a range of 435 nanometers to 470 nanometers;

a light guide plate, comprising a bottom surface and a plurality of screen dot recessed parts arranged in a two-dimensional manner, where the screen dot recessed parts are located on the bottom surface, each of the screen dot recessed parts is filled with a quantum dot material, and each quantum dot material has a yellow quantum dot material and a green quantum dot material; and

a substrate, disposed on the bottom surface of the light guide plate, and sealing the quantum dot material in the screen dot recessed parts of the light guide plate, where a refractive index coefficient of the substrate is less than or equal to a refractive index coefficient of the light guide plate, where

the density of the screen dot recessed parts disposed decreases in a direction towards the light source and increases in a direction away from the light source, where

each of the screen dot recessed parts further comprises a separation glue, used for sealing the quantum dot material.

In some embodiments, the substrate may comprise a reflective surface, to reflect light. The reflective surface may be made of a high reflectivity material, such as silver, aluminum, gold, chromium, copper, indium, iridium, nickel, platinum, rhenium, rhodium, tin, tantalum, tungsten, manganese, an alloy of any combination thereof, an anti-yellowing and heat-resistant white paint vehicle, or any combination of the foregoing materials, to reflect light.

In some embodiments, the light guide plate may be made by means of injection molding. The material of the light guide plate may be photocurable resin, polymethyl methacrylate (PMMA) or polycarbonate (PC), which is used for guiding light of the light source to a liquid crystal display panel. The light guide plate may have an out-light surface, a light-reflective surface, and a side in-light surface. The out-light surface is formed at a side of the light guide plate, and faces the liquid crystal display panel. The out-light surface may have cloudy surface processing or a scattering point design, to homogenize light extraction of the light guide plate and reduce a phenomenon of mura.

In some embodiments, the out-light surface may further comprise several protrusion structures, to further rectify the direction of light, increase a light gathering effect, and improve a front luminance. The protrusion structures may be, for example, a prismatic or semi-circular protrusion or recessed structure. The light-reflective surface is another side opposite to the out-light surface that forms the light guide plate, and is used for reflecting light to the out-light surface.

In some embodiments, the light-reflective surface may comprise a light guide structure, to reflect and guide light to inject from the out-light surface. For example, the light guide structure of the light-reflective surface is of a consecutive V-shaped structure, that is, a V-Cut structure, a cloudy surface structure, and a scattering point structure, to guide light of the light source to fully inject from the out-light surface. The side in-light surface is formed on one side or two opposite sides of the light guide plate and corresponds to the light source, and is used for permitting light emitted by the light source to enter the light guide plate. The side in-light surface may have, for example, a V-shaped (V-Cut) structure, an S-shaped wavy structure, or surface roughening processing (not shown), to increase light incident efficiency and light coupling efficiency of light.

In some embodiments, the light source may be, for example, a cold cathode fluorescent lamp (CCFL), a hot cathode fluorescent lamp (HCFL), a light-emitting diode (LED), an organic light emitting diode (OLED), a flat fluorescent lamp (FFL), a electro-luminescence (EL) component, a light bar, a laser light source, or any combination thereof.

In some embodiments, the backlight module may further comprise an optical film, such as a diffuser, a prism sheet, a turning prism sheet (TPS), a brightness enhancement film (BEF), a dual brightness enhancement film (DBEF), a diffused reflective polarizer film (DRPF), or any combination thereof, which is disposed on the light guide plate and used for improving an optical effect of light extraction of the light guide plate.

In the present disclosure, the quantum dot material is sealed on the light guide plate, to implement a quantum dot (QD) backlight module and a display apparatus.

### BRIEF DESCRIPTION OF THE DRAWINGS

FIG. 1a is a display diagram of light intensity of bands of light emitted by exemplary quantum dots;

FIG. 1b is a schematic diagram of an exemplary quantum dot lamp;

FIG. 1c is a schematic diagram of an exemplary quantum film;

FIG. 2 is a schematic diagram of an optical design of a light guide plate using a quantum dot material according to an embodiment of the present disclosure;

FIG. 3 is a spectrum display diagram of a white light source having red, green, and blue light that is of high color saturation and that is converted by means of excitation from a blue light source according to an embodiment of the present disclosure;

FIG. 4 is a schematic diagram of a designing manner of printed screen dots according to an embodiment of the present disclosure;

FIG. 5 is an architectural diagram of a display having a light guide plate according to an embodiment of the present disclosure;

FIG. 6 is a schematic diagram of a light guide plate according to an embodiment of the present disclosure;

FIG. 7 is a schematic diagram of a light guide plate having a quantum dot material according to an embodiment of the present disclosure; and

FIG. 8 is a top view of a light guide plate according to an embodiment of the present disclosure.

### DETAILED DESCRIPTION

The following embodiments are described with reference to the accompanying drawings, which are used to exemplify specific embodiments for implementation of the present disclosure. Terms about directions mentioned in the present disclosure, such as “on”, “below”, “front”, “back”, “left”, “right”, “in”, “out”, and “side surface” merely refer to directions of the accompanying drawings. Therefore, the used terms about directions are used to describe and understand the present disclosure, and are not intended to limit the present disclosure.

The accompanying drawings and the description are considered to be essentially exemplary, rather than limitative. In figures, units of similar structures are represented by using a same reference number. In addition, for understanding and ease of description, the size and the thickness of each component shown in the accompanying drawings are arbitrarily shown, but the present disclosure is not limited thereto.

In the accompanying drawings, for clarity, the thicknesses of a layer, a film, a panel, an area, and the like are enlarged. In the accompanying drawings, for understanding and ease of description, the thicknesses of some layers and areas are enlarged. It should be understood that when a component such as a layer, a membrane, an area, or a substrate is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that one is located on or below a target component, but does not mean that the one should be on the top of the gravity direction.

To further describe the technical means adopted in the present disclosure to achieve the preset invention objective and effects thereof, specific implementations, structures, features, and effects of a backlight module and a display apparatus provided according to the present disclosure are described in detail below with reference to the drawings and preferred embodiments.

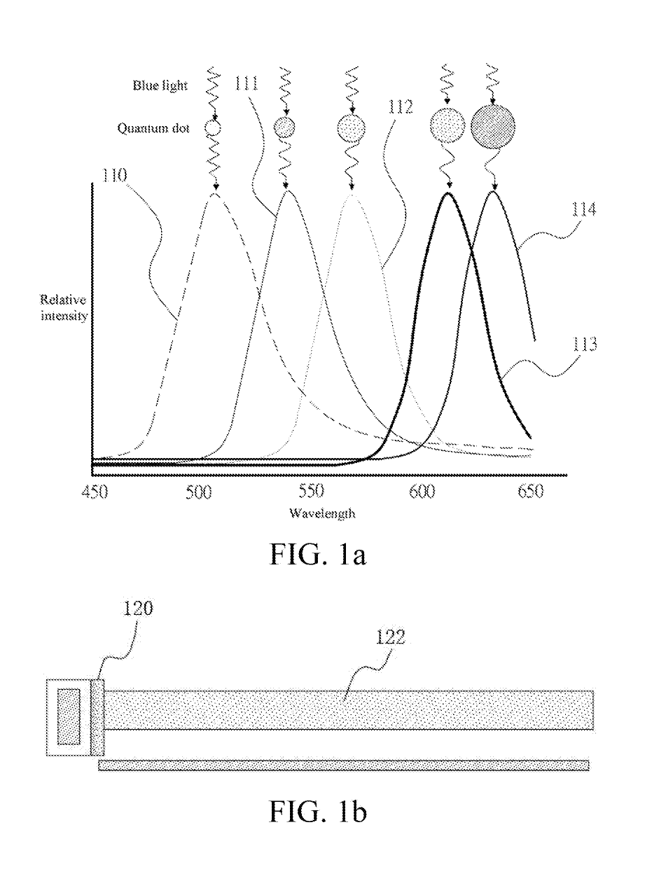

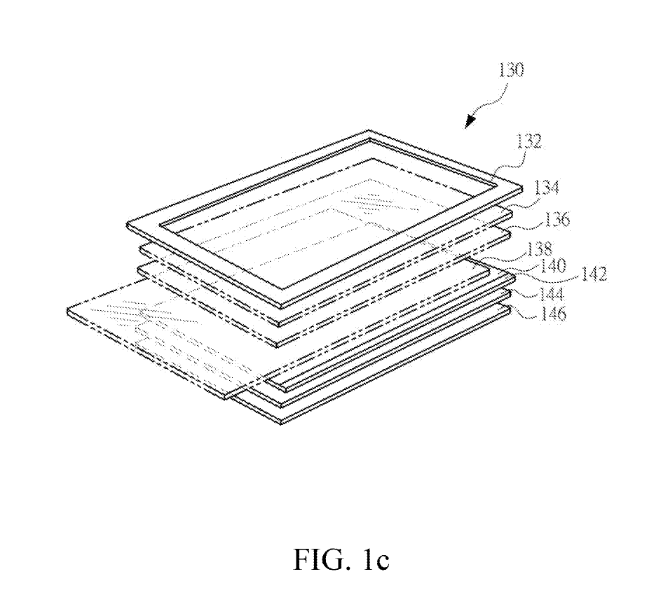

FIG. 1a is a display diagram of light intensity of bands of light emitted by known quantum dots, FIG. 1b is a diagram of an exemplary quantum dot lamp, and FIG. 1c is a diagram of an exemplary quantum film. Referring to FIG. 1a, to meet a higher requirement of human eyes on display colors, a wide color gamut is one of projects that need to be developed urgently in current display technologies. A quantum dot (referred to as QD below) display is a display manner of expanding a display color gamut. A display uses a QD luminescent material technology, generally because that the display has a feature of a relatively narrow emitting light wavelength (such as wavelengths of 110, 111, 112, 113, and 114 in FIG. 1a).

Referring to FIG. 1b and FIG. 1c, currently, methods for meeting a requirement on a wide color gamut display by using a QD technology are generally classified into the following two technologies. The first technology is a QD tube technology. That is, a quantum dot material is encapsulated in a glass lamp 122, then a blue light-emitting diode 120 is used as a light source (as shown in FIG. 1b) that excites the quantum dot material, and after the blue light excites the quantum dot material, quantum dots generate light of red and green spectrums, to obtain white light having spectrums of three colors of red, green, and blue. The other QD technology is referred to as a QD film (QD Film) technology. The QD film technology, as the name implies, encapsulates a quantum dot material in a thin film material as a sandwich structure, whose upper and lower films are protection thin films, and the quantum dot material (as shown in FIG. 1c) is placed in the middle of the structure. When light emitted by the blue light-emitting diode injects into the QD film, the quantum dot material in the QD film is excited to generate red and green spectrums, so as to generate a white light source.

Referring to FIG. 1c, FIG. 1c is an existing backlight module 130, including a backplane 146, a baffle plate 132 that is connected to the backplane 146 and that surrounds an accommodating space together with the backplane 146, a light guide plate 140 disposed in the accommodating space, a quantum dot enhancement film 138 disposed on a surface of the light guide plate 140 and located in the accommodating space, a light-emitting diode blue light source 142 disposed in the accommodating space, a reflector 144 disposed on a bottom surface of the light guide plate 140, and a plurality of optical films 134 and 136 overlaid on the light guide plate 140. Light emitted by the light source of the backlight module 130 is transmitted by the light guide plate 140. By means of a reflection action of the optical films 134 and 136, when the light penetrates the quantum dot enhancement film 138 from the light guide plate 140, the light still has a chance to be reflected and penetrates the quantum dot enhancement film 138 again. The light penetrates the quantum dot enhancement film 138 after being refracted many times, generates compensated light after a light mixing action, and then penetrates the optical films 134 and 136. In addition, when the light penetrates the light guide plate 140 and is reflected by the reflector 144, the light returns into the light guide plate 140, and after being refracted again, the light penetrates the quantum dot enhancement film 138 to generate the compensated light.

The two quantum point displays described above each have a disadvantage in a designing manner. To avoid a problem that a quantum dot material is invalid in a water vapor environment, the QD tube technology is generally used as a backlight source of a display. However, as described above, light of the QD tube needs to be converted twice (light from a light-emitting diode to a quantum dot lamp surface, and from the quantum dot lamp surface to the light guide plate). Consequently, the QD tube has a poor effect in light efficiency conversion. Moreover, on the appearance, because having one more tube, the QD tube cannot be designed with a narrow frame in its structure, and cannot be universally promoted in the current market. In another aspect, if the designing manner of the QD film is used, because a thin film encapsulation manner is used, water vapor cannot be separated completely and effectively. Consequently, on the periphery of the QD film, although there is a glue that separates water vapor, there is still a problem of an invalid area (that is, in the invalid area, the quantum dot material cannot be excited). Moreover, as to the excitation efficiency of the QD film in the blue light-emitting diode, because the QD film has an excitation process having only “one light path”, lower light emitting efficiency is resulted in. Therefore, generally, a double brightness enhanced film (DBEF) thin film material is matched in use, so that blue light can be reflected in a part between the reflection film and the DBEF and continue to excite the quantum dot material, to obtain a design of high light emitting efficiency. However, this designing manner needs to be matched with the DBEF. This dramatically increases design costs of the display, and is not widely used.

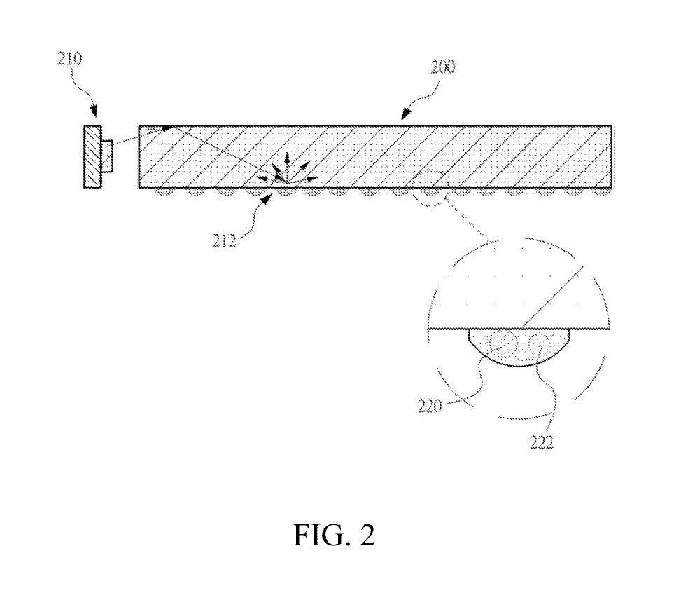

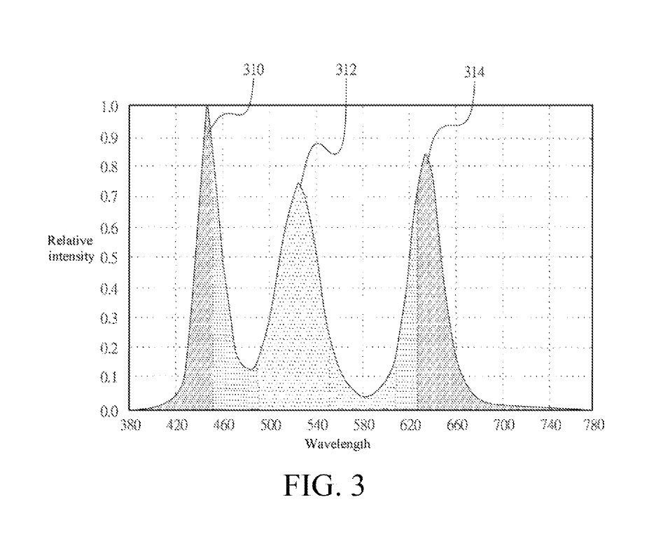

FIG. 2 is a diagram of an optical design of a light guide plate using a quantum dot material according to an embodiment of the present disclosure, and FIG. 3 is a spectrum display diagram of a white light source having red, green, and blue light that is of high color saturation and that is converted by means of excitation from a blue light source according to an embodiment of the present disclosure. Referring to FIG. 2 and FIG. 3, in an embodiment of the present disclosure, the present disclosure mainly provides an optical designing manner using a quantum dot material. The quantum dot material is distributed at a side of a light guide plate 200. By using features of the light guide plate 200, a blue light-emitting diode light source 210 guided into the light guide plate (LGP) 200 evenly converts a blue light-emitting diode line light source to a surface light source by means of particular distribution of screen dots 212 of the light guide plate 200, as shown in FIG. 2. It may be learned from FIG. 2 that the light source 210 is at the screen dots 212, and because the screen dots 212 damage a structure of total reflection of the light guide plate 200, the screen dots 212 may be considered as micro light sources which convert the blue light source 210 of the light-emitting diode to a flat light source. At the screen dots 212 of the light guide plate 200, quantum dot particle materials 220 of red light and green light are coated. That is, excited by the blue light source 210, spectrums (310, 312, and 314) of a white light source having red, green, and blue light of high color saturation are converted, as shown in FIG. 3. In addition, the coated quantum dot material 220 is sealed at the screen dots 212 of the light guide plate 200 by using a separation glue 222 that can separate water vapor, to form the light guide plate 200 that can have narrow bands of red and green light.

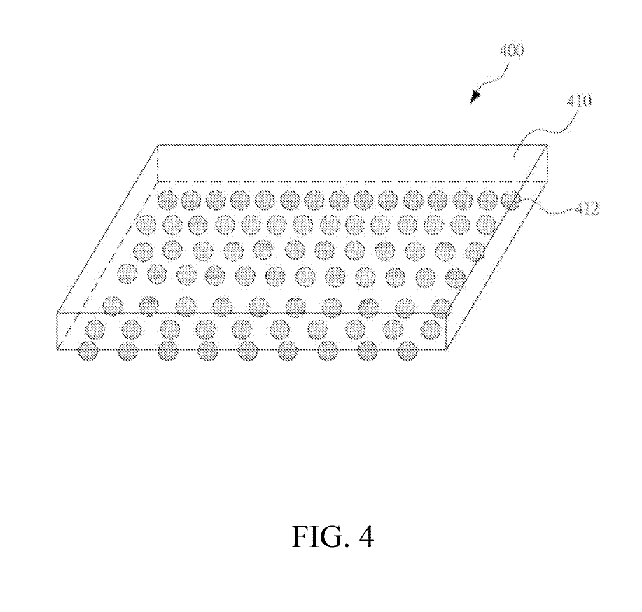

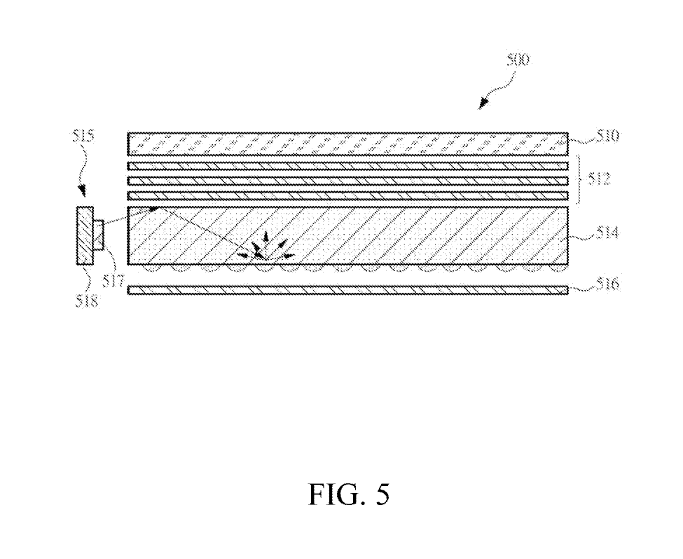

FIG. 4 is a schematic diagram of a designing manner of printed screen dots according to an embodiment of the present disclosure, and FIG. 5 is an architectural diagram of a display having a light guide plate according to an embodiment of the present disclosure. Referring to FIG. 4 and FIG. 5, in an embodiment of the present disclosure, an excitation light source 515 required in the present disclosure may be generally a blue light-emitting diode that has a relatively short band. Generally, blue light having a band in a range of 430 nm to 470 nm is used as the excitation light source 515. The excitation light source 515 is coupled to a light guide plate 514. The material of the light guide plate 514 may generally use PMMA or MS series. The thickness of the light guide plate 514 may be set matching the size of an encapsulated light-emitting diode. Currently, a relatively mainstream thickness is in a range of 0.5 mm to 3.0 mm, and different designs are made according to different display sizes. Generally, a television of a relatively large size is matched with a light guide plate of more than 2.0 mm. Later, by means of the selected light guide plate bare plate (not printed with screen dots) and a mixture of yellow and green quantum dot materials and a printing solvent, in a screen dot manufacturing process such as fabric card manufacturing, printing, and firing, the designed positions of the screen dots are distributed at a side of the light guide plate, to complete the light guide plate that has a light emitting feature of a quantum dot material. The quantum dot material is from the III-V family, or is a quantum dot material from the III-V family. The printing solvent material may be ink or other materials that can be screen-painted.

Referring to FIG. 2, FIG. 4, and FIG. 5, in an embodiment of the present disclosure, a light guide plate manufacturing method is provided. The light guide plate 514 has a mixture of the quantum dot material 220 and a painting solvent. By means of a screen dot manufacturing process such as fabric card manufacturing, printing, and firing, designed positions of screen dots 412 are distributed at a side of the light guide plate 514, to complete the light guide plate 514 that has a light emitting feature of the quantum dot material 220. The quantum dot material 220 is from the III-V family, or is a quantum dot material 220 from the III-V family. The printing solvent material may be ink or other materials that can be screen-painted.

Referring to FIG. 4, in an embodiment of the present disclosure, printed screen dots 412 on the light guide plate 410 are a distribution design in which blue light that injects from side light is evenly distributed as a flat light source in an optical simulation process.

Referring to FIG. 2, FIG. 4, and FIG. 5, in an embodiment of the present disclosure, a backlight module 400 includes: a light source 515, a light guide plate 514, a light emitting unit encapsulation member 518, and a quantum dot sealing member 517. The light source 515 uses a blue light-emitting diode as an excitation light source. The light guide plate 514 includes a bottom surface 410 and a plurality of screen dots 412 arranged in a two-dimensional manner. The screen dots 412 are located on the bottom surface 410, each screen dot 412 includes a quantum dot material 220, and the quantum dot material 220 is screen-painted on the bottom surface 410 of the light guide plate 514. By means of distribution of the screen dots 412 of the light guide plate 514, a line light source of the backlight module 400 is evenly converted into a surface light source. The light emitting unit encapsulation member 518 includes a light source substrate and a plurality of light emitting unit chips installed on the light source substrate. The quantum dot sealing member 517 is disposed in a light emitting direction of the light emitting unit encapsulation member 518. The backlight module 400 is a light source. The density of the screen dot recessed parts 412 decreases in a direction towards the light source and increases in a direction away from the light source. The quantum dot material 220 has a yellow quantum dot material and a green quantum dot material. Each screen dot 412 further includes a separation glue 222, used for sealing the quantum dot material 220.

Referring to FIG. 5, in an embodiment of the present disclosure, a display 500 having quantum dots includes: a light guide plate 514 exciting red and green light by using a light-emitting diode blue light source 515 and is connected to an optical film 512 (for example, a reflection film, a diffuser, and a prism film) and a reflector 516, and a display panel 510. A display having high color saturation may be designed.

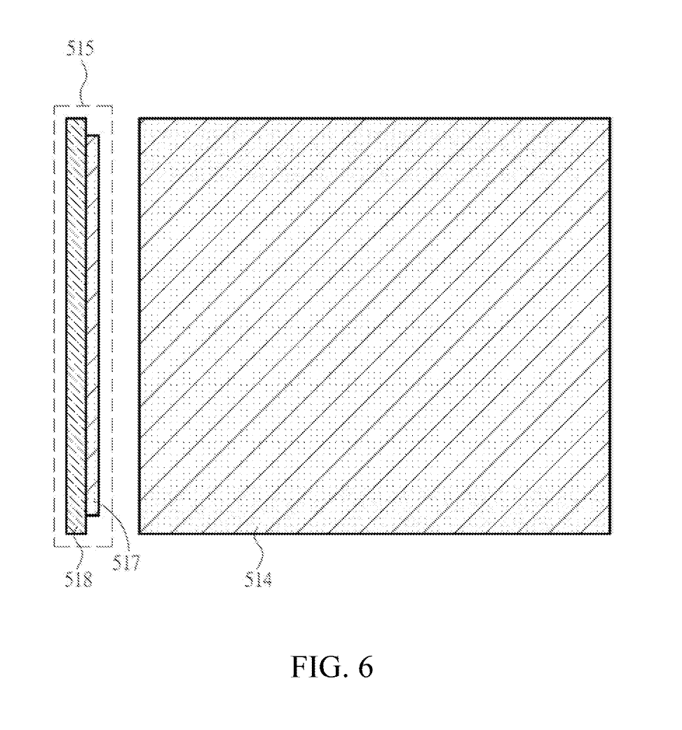

FIG. 6 is a diagram of a light guide plate according to an embodiment of the present disclosure. Referring to FIG. 6, in an embodiment of the present disclosure, the quantum dot sealing member 517 is directly connected to the light emitting unit encapsulation member 518.

Referring to FIG. 6, in an embodiment of the present disclosure, the sealing member 517 is a stripe-shaped tube or a flat-plate-shaped tube.

In an embodiment of the present disclosure, the plurality of light emitting unit chips is aligned in a line or a plurality of lines.

In an embodiment of the present disclosure, the plurality of light emitting unit chips is arranged in a straight-line, a curved line, or a preset pattern.

In an embodiment of the present disclosure, the quantum dot includes a silicon-based nanocrystal, an II-VI-family-based compound semiconductor nanocrystal, an III-V-family-based compound semiconductor nanocrystal, and any mixture thereof.

In an embodiment of the present disclosure, the plurality of light emitting unit chips is light-emitting diode chips.

In an embodiment of the present disclosure, the light source substrate is a printed circuit board, and the plurality of light emitting unit chips is directly installed on the light source substrate.

In an embodiment of the present disclosure, the light source substrate is a printed circuit board. Each light emitting unit chip encapsulation member or a plurality of light emitting unit chip encapsulation members is encapsulated into a chip encapsulation member, and each chip encapsulation member is installed on the light source substrate.

In an embodiment of the present disclosure, the plurality of light emitting unit chips is blue light-emitting diode chips, and the quantum dots inside the blue light-emitting diode chips include: a first quantum dot, whose size permits a band whose peak wavelength is in the wavelength of green light; and a second quantum dot, whose size permits a band whose peak wavelength is in the wavelength of red light.

In an embodiment of the present disclosure, blue light excited by the light source has a wavelength in a range of 435 nanometers to 470 nanometers.

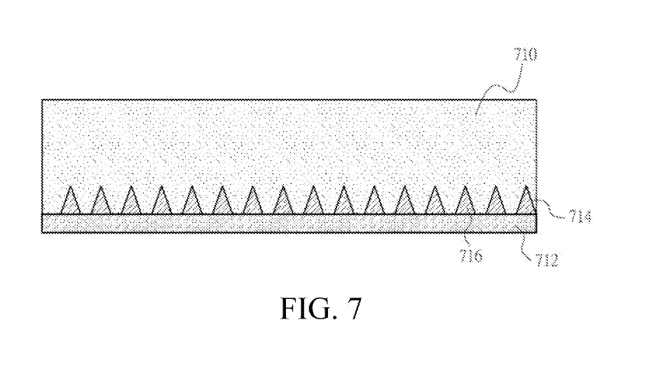

FIG. 7 is a schematic diagram of a light guide plate having a quantum dot material according to an embodiment of the present disclosure. Referring to FIG. 7, in an embodiment of the present disclosure, a light guide plate 710 having a quantum dot material includes a substrate 712 and a plurality of screen dot recessed parts 714 arranged in a two-dimensional manner. The screen dot recessed parts 714 are located on the substrate 712, and each of the screen dot recessed parts 714 is filled with a quantum dot material 716. By means of distribution of the screen dot recessed parts 714 of the light guide plate 710, a line light source of the backlight module is evenly converted into a surface light source.

Specifically, the screen dot recessed part 714 is formed on a bottom surface of the light guide plate 710, and each of the screen dot recessed parts 714 is filled with the quantum dot material 716. The substrate 712 is disposed on the bottom surface of the light guide plate 710, and seals the quantum dot material 716 in the screen dot recessed parts 714 of the light guide plate.

In some embodiments, the substrate 712 may include a reflective surface, to reflect light. The reflective surface may be made of a high reflectivity material, such as silver, aluminum, gold, chromium, copper, indium, iridium, nickel, platinum, rhenium, rhodium, tin, tantalum, tungsten, manganese, an alloy of any combination thereof, an anti-yellowing and heat-resistant white paint vehicle, or any combination of the foregoing materials, to reflect light.

In some embodiments, a refractive index coefficient of the substrate 712 is less than or equal to a refractive index coefficient of the light guide plate, so as to form total reflection between the light guide plate 710 and the substrate 712 and reflect light.

In some embodiments, light excited by the light source has a wavelength in a range of 435 nanometers to 470 nanometers.

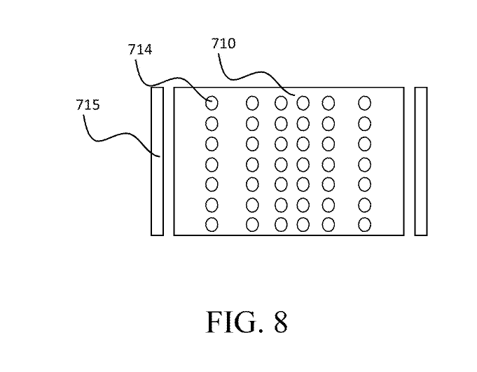

In some embodiments, as shown in FIG. 8, the density of the screen dot recessed parts 714 disposed decreases in a direction towards the light source and increases in a direction away from the light source.

In some embodiments, the quantum dot material has a yellow quantum dot material and a green quantum dot material.

In some embodiments, each of the screen dot recessed parts 714 further includes a separation glue, used for sealing the quantum dot material 716, to avoid water vapor.

In different embodiments, the light guide plate 710 may be made by means of injection molding. The material of the light guide plate may be photocurable resin, polymethyl methacrylate (PMMA) or polycarbonate (PC), which is used for guiding light of the light source to a liquid crystal display panel. The light guide plate may have an out-light surface, a light-reflective surface, and a side in-light surface. The out-light surface is formed at a side of the light guide plate, and faces the liquid crystal display panel. The out-light surface may have cloudy surface processing or a scattering point design, to homogenize light extraction of the light guide plate and reduce a phenomenon of mura. In another embodiment, the out-light surface may further include several protrusion structures (not shown), to further rectify the direction of light, increase a light gathering effect, and improve a front luminance. The protrusion structures may be, for example, a prismatic or semi-circular protrusion or recessed structure. The light-reflective surface is another side opposite to the out-light surface that forms the light guide plate, and is used for reflecting light to the out-light surface. In this embodiment, the light-reflective surface of the light guide plate may be parallel to the out-light surface. The light-reflective surface may include a light guide structure (not shown), to reflect and guide light to inject from the out-light surface. For example, the light guide structure of the light-reflective surface is of a consecutive V-shaped structure, that is, a V-Cut structure, a cloudy surface structure, and a scattering point structure, to guide light of the light source to fully inject from the out-light surface. The side in-light surface is formed on one side or two opposite sides of the light guide plate and corresponds to the light source, and is used for permitting light emitted by the light source to enter the light guide plate. The side in-light surface may have, for example, a V-shaped (V-Cut) structure, an S-shaped wavy structure, or surface roughening processing (not shown), to increase light incident efficiency and light coupling efficiency of light.

The light source in the present disclosure may be, for example, a cold cathode fluorescent lamp (CCFL), a hot cathode fluorescent lamp (HCFL), a light-emitting diode (LED), an organic light emitting diode (OLED), a flat fluorescent lamp (FFL), a electro-luminescence (EL) component, a light bar, a laser light source, or any combination thereof.

The backlight module in the present disclosure may further include an optical film, such as a diffuser, a prism sheet, a turning prism sheet (TPS), a brightness enhancement film (BEF), a dual brightness enhancement film (DBEF), a diffused reflective polarizer film (DRPF), or any combination thereof, which is disposed on the light guide plate, and used for improving an optical effect of light extraction of the light guide plate.

The display in the present disclosure is based on an original LCD display and does not need to add an optical component, so that an original designing manner of modules is not affected; a stationing material of an original light guide plate is improved, and a quantum dot material is introduced as an excitation light source without a need of increasing additional component costs; and a total reflection principle of the light guide plate may be used, to repeatedly excite the quantum dot material to increase conversion efficiency of red and green light.

Terms such as “in some embodiments” and “in various embodiments” are repeatedly used. Usually, the terms do not refer to a same embodiment; but they may refer to a same embodiment. Words such as “comprise”, “have”, “include” are synonyms, unless other meanings are indicated in the context.

The foregoing descriptions are merely preferred embodiments of the present disclosure, and are not intended to limit the present disclosure in any form. Although the present disclosure has been disclosed above through the preferred embodiments, the embodiments are not intended to limit the present disclosure. Any person skilled in the art can make some equivalent variations or modifications according to the foregoing disclosed technical content without departing from the scope of the technical solutions of the present disclosure to obtain equivalent embodiments. Any simple amendment, equivalent change or modification made to the foregoing embodiments according to the technical essence of the present disclosure without departing from the content of the technical solutions of the present disclosure shall fall within the scope of the technical solutions of the present disclosure.

What is claimed is:

1. A backlight module, comprising:
at least one light source;
a light guide plate, comprising a bottom surface and a plurality of screen dot recessed parts arranged in a two-dimensional manner, wherein the screen dot recessed parts are located on the bottom surface, and each of the screen dot recessed parts is filled with a quantum dot material; and
a substrate, disposed on the bottom surface of the light guide plate, and sealing the quantum dot material in the screen dot recessed parts of the light guide plate.

2. The backlight module according to claim 1, wherein the substrate comprises a reflective surface.

3. The backlight module according to claim 1, wherein a refractive index coefficient of the substrate is less than or equal to a refractive index coefficient of the light guide plate.

4. The backlight module according to claim 1, wherein light excited by the light source has a wavelength in a range of 435 nanometers to 470 nanometers.

5. The backlight module according to claim 1, wherein the density of the screen dot recessed parts disposed decreases in a direction towards the light source and increases in a direction away from the light source.

6. The backlight module according to claim 1, wherein the quantum dot material has a yellow quantum dot material and a green quantum dot material.

7. The backlight module according to claim 1, wherein each of the screen dot recessed parts further comprises a separation glue, used for sealing the quantum dot material.

8. A display apparatus, comprising:
a display panel, configured to display an image; and
a backlight module, comprising:
at least one light source;
a light guide plate, comprising a bottom surface and a plurality of screen dot recessed parts arranged in a two-dimensional manner, wherein the screen dot recessed parts are located on the bottom surface, and each of the screen dot recessed parts is filled with a quantum dot material; and
a substrate, disposed on the bottom surface of the light guide plate, and sealing the quantum dot material in the screen dot recessed parts of the light guide plate.

9. The display apparatus according to claim 8, wherein the substrate comprises a reflective surface.

10. The display apparatus according to claim 8, wherein a refractive index coefficient of the substrate is less than or equal to a refractive index coefficient of the light guide plate.

11. The display apparatus according to claim 8, wherein light excited by the light source has a wavelength in a range of 435 nanometers to 470 nanometers.

12. The display apparatus according to claim 8, wherein the density of the screen dot recessed parts disposed decreases in a direction towards the light source and increases in a direction away from the light source.

13. The display apparatus according to claim 8, wherein the quantum dot material has a yellow quantum dot material and a green quantum dot material.

14. The display apparatus according to claim 8, wherein each of the screen dot recessed parts further comprises a separation glue, used for sealing the quantum dot material.

15. A backlight module, comprising:
at least one light source, exciting light having a wavelength in a range of 435 nanometers to 470 nanometers;
a light guide plate, comprising a bottom surface and a plurality of screen dot recessed parts arranged in a two-dimensional manner, wherein the screen dot recessed parts are located on the bottom surface, each of the screen dot recessed parts is filled with a quantum dot material, and each quantum dot material has a yellow quantum dot material and a green quantum dot material; and
a substrate, disposed on the bottom surface of the light guide plate, and sealing the quantum dot material in the screen dot recessed parts of the light guide plate, wherein a refractive index coefficient of the substrate is less than or equal to a refractive index coefficient of the light guide plate, wherein
the density of the screen dot recessed parts disposed decreases in a direction towards the light source and increases in a direction away from the light source, wherein
each of the screen dot recessed parts further comprises a separation glue, used for sealing the quantum dot material.
